(19) United States
(12) Patent Application Publication
(10) Pub. No.: US 2007/0133625 A1
(43) Pub. Date: Jun. 14, 2007

(54) All-fiber laser device for mid-infrared wavelength band

(76) Inventors: Joon Tae Ahn, Daejeon-city (KR); Woon Jin Chung, Seoul (KR); Hong Seok Seo, Daejeon-city (KR); Bong Je Park, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/450,235

(22) Filed: Jun. 9, 2006

(30) Foreign Application Priority Data
Dec. 12, 2005 (KR) 10-2005-0121974

(51) Int. Cl. H01S 3/30; G02B 6/02

(52) U.S. Cl. 372/6; 385/123

(57) ABSTRACT

Provided is an all-fiber laser device oscillating in a mid-infrared wavelength band. The laser device uses a non-silica optical fiber for a gain medium. The non-silica optical fiber includes a core doped with a rare element having an energy transition level corresponding to the mid-infrared wavelength band. A Fabry-Parrot resonator or a ring-shaped resonator may be installed in the non-silica optical fiber. Alternatively, a silica optical fiber may be coupled to both ends of the non-silica optical fiber, and a Fabry-Parrot resonator or a ring-shaped resonator may be installed in the silica optical fiber.

### CROSS-REFERENCE TO RELATED PATENT APPLICATION

This application claims the benefit of Korean Patent Application No. 10-2005-0121974, filed on Dec. 12, 2005, in the Korean Intellectual Property Office, the disclosure of which is incorporated herein in its entirety by reference.

### BACKGROUND OF THE INVENTION

1. Field of the Invention

The present invention relates to a fiber laser device, and more particularly, to an all-fiber laser device for a mid-infrared wavelength band.

2. Description of the Related Art

Since a fiber laser device allows a pump ray and a laser ray to propagate through an optical fiber, the fiber laser device has a high conversion efficiency of the pump ray, and has a simple resonator because optical parts do not need to be aligned. The fiber laser device has a stable output and an excellent mode characteristic of an output ray because an alignment of a resonator is not ruined. Also, the fiber laser device allows a terminal of an optical fiber through which a ray is outputted to be freely moved, and thus may be used conveniently. Therefore, the fiber laser device is currently developed and studied actively.

The fiber laser device includes a Yb fiber laser device oscillating in a wavelength band 1 μm, an Er fiber laser device oscillating in a wavelength band 1.5 μm, and a Tm fiber laser device oscillating in a wavelength band 2 μm. These optical fiber lasers use cores of an optical fiber doped with a rare earth element required for laser oscillation, for their gain media. These fiber laser devices are commercialized as a high power or wavelength tunable laser and applied to a variety of fields such as industries, medical treatments, military affairs, and scientific researches.

A fiber laser device operating in a mid-infrared wavelength band starting from more than 2 μm, specifically, more than 3 μm is required for the medical treatments, environments, and military affairs. The Yb fiber laser device, the Er fiber laser device, and the Tm fiber laser device are silica-optical fiber devices. The silica-optical fiber devices generally have a wavelength band less than 2 μm. Accordingly, a fiber laser device has been proposed to have a mid-infrared wavelength band using a bulk-optic device.

FIG. 1 is a view of a fiber laser device for a mid-infrared wavelength band using a bulk-optic device according to a prior art.

In detail, FIG. 1 illustrates contents published by Zhu of New Mexico University in the United States with the title “5 W Diode Pumped Compact Mid-IR Fiber Laser at 2.7 μm” at a LEOS 2004 academic conference. An optical laser device 10 illustrated in FIG. 1 uses a collimated laser diode (LD) for a pump light source 12, uses a bulk-optic device such as a dichroic mirror 14, a lens 16, and a filter 20, and uses a fluoride fiber 18 doped with Er or Pr for a gain medium of an optical fiber. Arrows in FIG. 1 represent the movement direction of light, and a reference numeral 22 is a power meter.

The fiber laser device illustrated in FIG. 1 uses a Fabry-Parrot resonator, which utilizes Fresnel reflection occurring at both ends of a fluoride fiber 18, for a resonator for laser oscillation. The dichroic mirror 14 transmits a pumped ray but reflects a ray generated from the laser oscillation. When a ray from the pump light source 12 is incident to the fluoride fiber 18 through the dichroic mirror 14, a laser resonator is formed by reflections occurring at both ends of the fluoride fiber 18, so that the laser oscillation occurs. The fiber laser device 10 illustrated in FIG. 1 uses two pump light sources 12 in order to obtain a high power laser characteristic.

FIG. 2 is a view of a fiber laser device for a mid-infrared wavelength band using a bulk-optic device according to another prior art.

In detail, FIG. 2 illustrates contents published by S. D. Jackson of Sydney University in Australia with the title “Single-transverse-mode 2.5 W holmium-doped fluoride fiber laser operating at 2.86 μm” in the February issue, 2004 of Optics Letters. A fiber laser device 30 illustrated in FIG. 2 includes bulk-optic devices such as a dichroic mirror 44 and a high reflecting mirror 42, a gain medium formed of a fluoride fiber 40 doped with Ho and Pr, and an optical fiber laser for a pump light source. The optical fiber laser for the pump light source includes a diode pump 32, a dichroic mirror 46, and a silica optical fiber 34 doped with Yb.

A ray from the optical fiber laser for the pump light source passes through a pair of objective lenses 36 and 38 and the dichroic mirror 44, which transmits a ray from the pump light source and reflects a ray having a laser oscillation wavelength, and then is incident to the fluoride fiber 40 doped with Ho and Pr. The fiber laser device 30 obtains laser oscillation using a Fabry-Parrot resonator, which utilizes a high reflecting mirror 42 attached at one end of the fluoride fiber 40 and Fresnel reflection occurring at the other end of the fluoride fiber 40.

The prior art fiber laser devices 10 and 30 for the mid-infrared wavelength band illustrated in FIGS. 1 and 2 oscillate near a wavelength band of 2.7-2.8 μm, and use the fluoride fibers 18, 34, and 40 doped with Er, Pr, Yb, or Ho for their gain media. The fiber laser devices 10 and 30 illustrated in FIGS. 1 and 2 obtain excellent performances such as power of more than 1W but do not sufficiently represent advantages of the fiber laser devices because they are not all-fiber laser devices.

In other words, the prior art fiber laser devices 10 and 30 that utilize the bulk-optic devices illustrated in FIGS. 1 and 2 have considerably low performance in aspects of a pumping efficiency, long-term stability, and use convenience of an output ray, compared to the all-fiber laser devices.

### SUMMARY OF THE INVENTION

The present invention provides an all-fiber laser device including only an optical fiber without a bulk-optic device and oscillating in a mid-infrared wavelength band of 3-4 μm.

According to an aspect of the present invention, there is provided an all-fiber laser device for a mid-infrared wavelength band, capable of inputting and pumping a pump ray to an optical fiber to output a laser ray. The fiber may include a non-silica optical fiber with a core doped with a rare earth element having an energy transition level corresponding to the mid-infrared wavelength band, the non-silica optical fiber being used for a gain medium. The rare earth element may be one element selected from the group consisting of Pr, Tb, Dy, Nd, Pm, Sm, Eu, Gd, Ho, Er, Tm, and Yb.

According to an aspect of the present invention, there is provided an all-fiber laser device for a mid-infrared wavelength band, the laser device including: a non-silica optical fiber with a core doped with a rare earth element having an energy transition level corresponding to the mid-infrared wavelength band, the non-silica optical fiber being used for a gain medium; a pump light source coupled to the non-silica optical fiber through an optical coupler installed in the non-silica optical fiber; and an optical device installed in the non-silica optical fiber to constitute a resonator.

The rare earth element may be one element selected from the group consisting of Pr, Tb, Dy, Nd, Pm, Sm, Eu, Gd, Ho, Er, Tm, and Yb. The optical device constituting the resonator may be formed of a Bragg grating and thus the resonator may be a Fabry-Parrot resonator.

The optical device may include an optical isolator installed in the non-silica optical fiber and generating laser oscillation in only one direction, and a band-pass optical filter installed in the non-silica optical fiber and selecting a laser oscillation wavelength. The optical isolator and the band-pass optical filter may be connected with each other in a ring shape, so that the resonator is a ring-shaped resonator, and an optical fiber coupler is installed in the non-silica optical fiber to output a ray.

According to another aspect of the present invention, there is provided an all-fiber laser device for a mid-infrared wavelength band, the laser device including: a non-silica optical fiber with a core doped with a rare earth element having an energy transition level corresponding to the mid-infrared wavelength band, the non-silica optical fiber being used for a gain medium; a silica optical fiber connected to both ends of the non-silica optical fiber; a pump light source coupled to the non-silica optical fiber through an optical coupler installed in the non-silica optical fiber; and an optical device installed in the non-silica optical fiber to constitute a resonator.

The rare earth element may be one element selected from the group consisting of Pr, Tb, Dy, Nd, Pm, Sm, Eu, Gd, Ho, Er, Tm, and Yb. The optical device constituting the resonator may be formed of a Bragg grating and thus the resonator may be a Fabry-Parrot resonator. The optical device may include an optical isolator installed in the silica optical fiber and generating laser oscillation in only one direction, and a band-pass optical filter installed in the silica optical fiber and selecting a laser oscillation wavelength, the optical isolator and the band-pass optical filter may be connected with each other in a ring shape, so that the resonator is a ring-shaped resonator, and an optical fiber coupler may be installed in the silica optical fiber to output a ray.

### BRIEF DESCRIPTION OF THE DRAWINGS

The above and other features and advantages of the present invention will become more apparent by describing in detail exemplary embodiments thereof with reference to the attached drawings in which:

FIG. 1 is a view of a fiber laser device for a mid-infrared wavelength band using a bulk-optic device according to a prior art;

FIG. 2 is a view of a fiber laser device for a mid-infrared wavelength band using a bulk-optic device according to another prior art;

FIG. 3 is a view of an all-fiber laser device for a mid-infrared wavelength band according to an embodiment of the present invention;

FIG. 4 is a view of an all-fiber laser device for a mid-infrared wavelength band according to another embodiment of the present invention;

FIG. 5 is a graph illustrating transmittance of a silica optical fiber for each wavelength according to the present invention;

FIG. 6 is a view of an all-fiber laser device for a mid-infrared wavelength band according to another embodiment of the present invention; and

FIG. 7 is a view of an all-fiber laser device for a mid-infrared wavelength band according to another embodiment of the present invention.

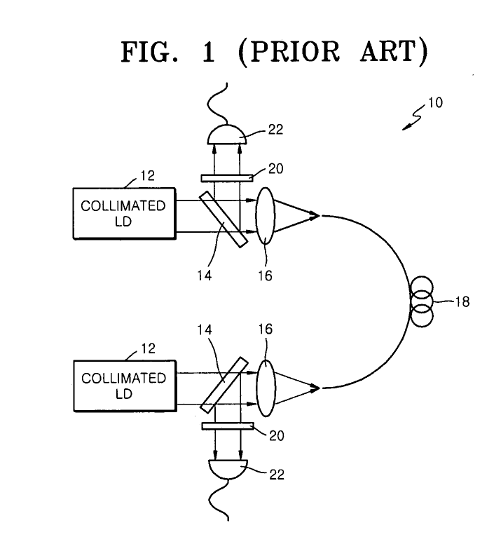

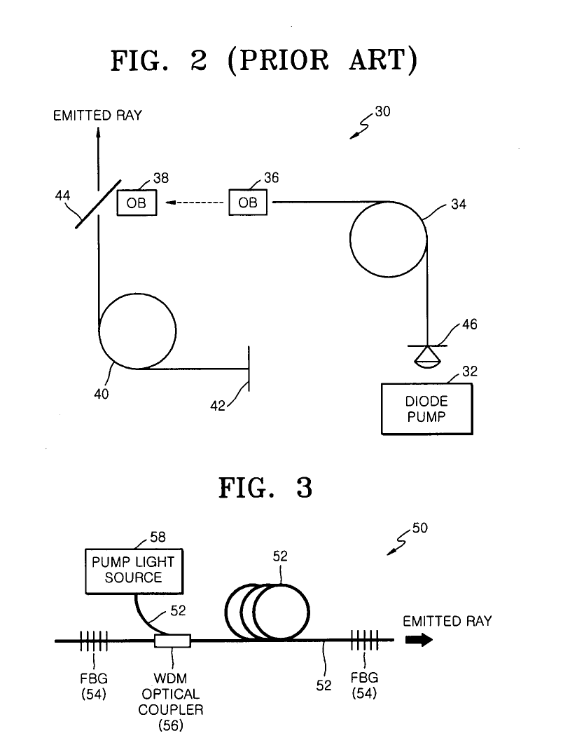

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

Generally, a fiber laser device may efficiently oscillate when the phonon energy of an optical fiber used for a gain medium decreases as a laser oscillation wavelength increases. Since a silica optical fiber for a gain medium has a high phonon energy, which is 1100 cm⁻¹, it is not suitable for a fiber laser device oscillating in a mid-infrared wavelength band.

Therefore, the inventors of the present invention have paid attention to the fact that an optical fiber made of non-silica glass (referred to as a non-silica optical fiber) has a low phonon energy and thus may be used for a gain medium of a fiber laser device for a mid-infrared wavelength band. The non-silica optical fiber that may be used for the present invention includes a fluoride fiber, sulfide fiber, and selenide fiber. Regarding the phonon energy, the fluoride fiber has about 600 cm⁻¹, the sulfide fiber has about 350 cm⁻¹, and the selenide fiber has about 250 cm⁻¹, which are relatively low phonon energies compared to that of the silica optical fiber.

FIG. 3 is a view of an all-fiber laser device for a mid-infrared wavelength band according to an embodiment of the present invention.

In detail, FIG. 3 illustrates a Fabry-Parrot resonator all-fiber laser device 50 capable of emitting a ray having a mid-infrared wavelength using only a non-silica optical fiber 52. The Fabry-Parrot resonator all-fiber laser device 50 uses a non-silica optical fiber 52, which is suitable for lasing a ray in the mid-infrared wavelength band, for a gain medium. The non-silica optical fiber 52 includes a core doped with a rare earth element having an energy transition level corresponding to the mid-infrared wavelength band. The rare earth element includes of Pr, Tb, Dy, Nd, Pm, Sm, Eu, Gd, Ho, Er, Tm, and Yb.

An optical device constituting the Fabry-Parrot resonator, namely, a fiber Bragg grating (FBG) 54 is coupled to the non-silica optical fiber 52. Also, a wavelength division multiplexing (WDM) optical coupler 56 is installed in the non-silica optical fiber 52. A pump light source 58 is connected to the WDM optical coupler 56 using a non-silica optical fiber 52. The pump light source 58 may be a laser diode (LD). The FBG 54 may be manufactured by forming a grating in the non-silica optical fiber 52. The WDM optical coupler 56 fully couples a ray from the pump light source 58 and fully transmits a lasing ray. The WDM optical coupler 56 may be an all-fiber WDM coupler or a WDM coupler formed by connecting an optical fiber to a thin film filter.

In operation, when a ray from the pump light source 58 is incident to the non-silica optical fiber 52 through the WDM optical coupler 56, the ray is pumped in the Fabry-Parrot resonator including the FBG pairs 54 and emitted as a ray in the mid-infrared wavelength band.

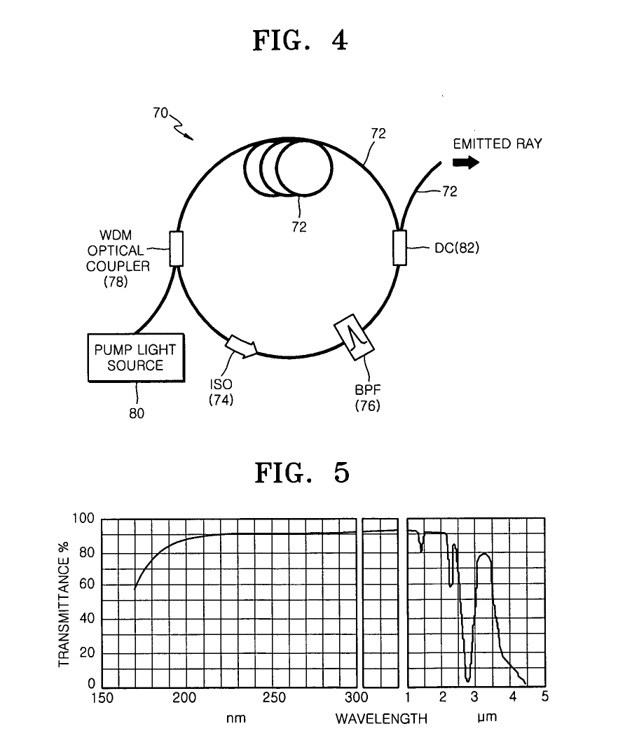

FIG. 4 is a view of an all-fiber laser device for a mid-infrared wavelength band according to another embodiment of the present invention.

In detail, FIG. 4 illustrates a ring-shaped all-fiber laser device 70 capable of emitting a ray having a mid-infrared wavelength using only a non-silica optical fiber 72. The ring-shaped all-fiber laser device 70 uses a non-silica optical fiber 72, which is suitable for lasing a ray in the mid-infrared wavelength band, for a gain medium. The non-silica optical fiber 72 includes a core doped with a rare earth element having an energy transition level corresponding to the mid-infrared wavelength band. The rare earth element includes of Pr, Tb, Dy, Nd, Pm, Sm, Eu, Gd, Ho, Er, Tm, and Yb.

An optical device constituting the ring-shaped resonator, namely, an optical isolator (ISO) 74 and a band-pass optical filter (BPF) 76 are connected in a ring (circular) shape to the non-silica optical fiber 72. The optical ISO 74 transmits a ray propagating in an arrow direction and blocks a ray propagating in an opposite direction, and thus allows lasing to be generated in only one direction of two directions of the ring-shaped resonator. The optical ISO 74 may be a bulk or miniature optical ISO. The ring-shaped fiber laser device 70 is manufactured by pig-tailing the non-silica optical fiber to the bulk or miniature optical ISO. The band-pass optical filter 76 is designed for selecting a ray to be lased.

A WDM optical coupler 78, a pump light source 80, and an optical coupler (DC) are installed in directional non-silica optical fiber 72. The pump light source 80 is connected to the WDM optical coupler 78 using the non-silica optical fiber 72. The pump light source 58 may be a laser diode. The optical directional coupler 82 takes out part of the intensities of rays oscillating in the ring-shaped resonator to obtain a laser output. The optical directional coupler 82 may be an all-fiber optical coupler or an optical coupler formed by connecting an optical fiber to a thin film filter.

In operation, when a ray from the pump light source 80 is incident to the non-silica optical fiber 72 through the WDM optical coupler 78, the ray is pumped in the ring-shaped resonator including the optical ISO 74 and the band-pass optical filter 76, and emitted as a ray in the mid-infrared wavelength band through the optical directional coupler 82.

It is known that the silica optical fiber has high transmittance more than 90% in a wavelength band less than 2.0 μm and so it is widely used for a range between a visible wavelength region and a near infrared wavelength region. Also, it is considered that the silica optical fiber has a drastic increase in light loss for a ray with a long wavelength greater than 2.0 μm. Therefore, the inventors of the present invention have examined the transmittance characteristic of the silica optical fiber over the entire wavelength band.

FIG. 5 is a graph illustrating the transmittance of a silica optical fiber for each wavelength according to the present invention.

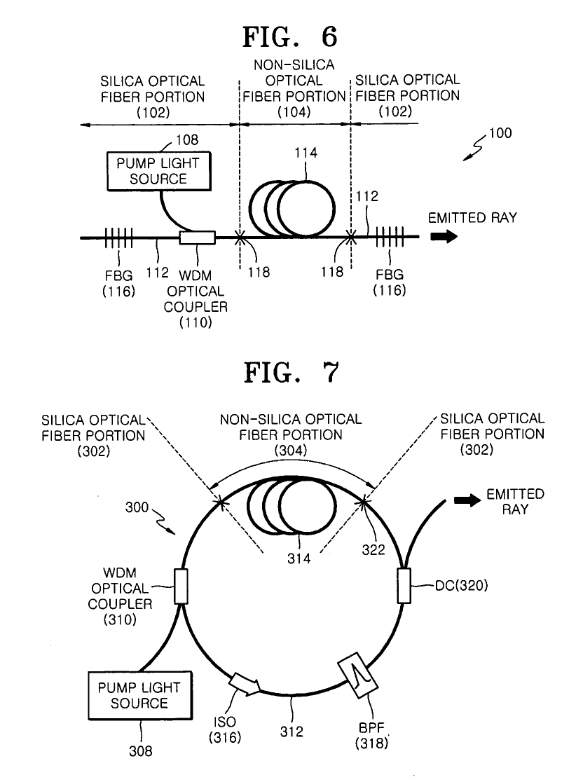

In detail, the inventors of the present invention have examined the transmittance characteristic of the silica optical fiber and illustrated results thereof in FIG. 5. Referring to FIG. 5, a transmission band having transmittance of about 70% or more exists even in a wavelength band 3 μm through about 500 nm, and maximum transmittance is about 80%. According to the transmittance characteristic of the silica optical fiber for the mid-infrared wavelength band examined by the inventors of the present invention, although the silica optical fiber may not be used for a gain optical fiber for the mid-infrared wavelength band due to its high phonon energy, the silica optical fiber may be used as an optical pipe conveying a laser ray. Therefore, optical devices required for a laser resonator are manufactured using the silica optical fiber, and then fuse-connected, so that it is possible to realize an all-fiber laser for the mid-infrared wavelength band, which will be described with reference to FIGS. 6 and 7.

FIG. 6 is a view of an all-fiber laser device for a mid-infrared wavelength band according to another embodiment of the present invention.

In detail, FIG. 6 illustrates the all-fiber laser device 100 including a non-silica optical fiber 114 and a silica optical fiber 112 connected in a hybrid type to emit a laser ray in a mid-infrared wavelength band. The fiber laser device 100 is divided into a non-silica optical fiber part 104 and a silica optical fiber part 102. That is, FIG. 6 illustrates the all-fiber Fabry-Parrot resonator laser device 100 for the mid-infrared wavelength band.

The all-fiber Fabry-Parrot resonator laser device 100 uses the non-silica optical fiber 114, which is suitable for lasing a ray in the mid-infrared wavelength band, for a gain medium. The non-silica optical fiber 114 includes a core doped with a rare earth element having an energy transition level corresponding to the mid-infrared wavelength band. The rare earth element includes of Pr, Tb, Dy, Nd, Pm, Sm, Eu, Gd, Ho, Er, Tm, and Yb.

The silica optical fiber 112 is connected to both ends of the non-silica optical fiber 114, and a pair of FBGs 116 is connected to the silica optical fiber 112, so that a resonator is formed. The FBGs 116 are manufactured by forming gratings in the silica fiber 112. A WDM optical coupler 110 is connected to the silica optical fiber 112.

A pump light source 108 is connected to the WDM optical coupler 110. The pump light source 108 may be a laser diode. Connection points 118 between the non-silica optical fiber 114 and the silica optical fiber 112 are denoted by a symbol x. The non-silica optical fiber 114 and the silica optical fiber 112 have a large difference in their refractive indexes, so that optical connection is performed with low loss when they are connected.

In operation, when a ray from the pump light source 108 is incident to the silica optical fiber 112 through the WDM optical coupler 110, the ray is pumped in the Fabry-Parrot resonator including a pair of FBGs 116 and emitted as a ray in the mid-infrared wavelength band.

FIG. 7 is a view of an all-fiber laser device for a mid-infrared wavelength band according to another embodiment of the present invention.

In detail, the ring shaped resonator all-fiber laser device 300 illustrated in FIG. 7 includes a non-silica optical fiber 314 and a silica optical fiber 312 connected in a hybrid type. The fiber laser device 300 is divided into a non-silica optical fiber part 304 and a silica optical fiber part 302. That is, FIG. 7 illustrates the all-fiber ring-shaped resonator laser device for the mid-infrared wavelength band.

The ring-shaped resonator all-fiber laser device 300 uses the non-silica optical fiber 314, which is suitable for lasing a ray in the mid-infrared wavelength band, for a gain medium. The non-silica optical fiber 314 includes a core doped with a rare earth element having an energy transition level corresponding to the mid-infrared wavelength band. The rare earth element includes of Pr, Tb, Dy, Nd, Pm, Sm, Eu, Gd, Ho, Er, Tm, and Yb.

The silica optical fiber 312 is connected at both ends of the non-silica optical fiber 314. An optical ISO 316 and a band-pass optical filter (BPF) 318 are connected in a ring shape to the silica optical fiber 312 to constitute a resonator. A WDM optical coupler 310 and an optical directional coupler (DC) 320 are connected to the silica optical fiber. A pump light source 308 is connected to the WDM optical coupler 310. The pump light source may be a laser diode. Connection points 322 between the non-silica optical fiber 314 and the silica optical fiber 312 are denoted by a symbol x. The non-silica optical fiber 314 and the silica optical fiber 312 have a large difference in their refractive indexes, so that optical connection is performed with low loss when they are connected.

In operation, when a ray from the pump light source 308 is incident to the silica optical fiber 312 through the WDM optical coupler 310, the ray is pumped in the ring-shaped resonator that connects the optical ISO 316 with the BPF 318 in a ring shape and emitted as a ray in the mid-infrared wavelength band through the optical fiber DC 320. The optical ISO 316 is designed for allowing lasing to be generated in only one direction in the ring-shaped resonator, and the BPF 31876 is designed for selecting a ray to be lased.

As described above, the present invention does not use a bulk-optic device, but uses a non-silica optical fiber including a core doped with a rare earth element having an energy transition level corresponding to the mid-infrared wavelength band for the gain medium of the optical fiber, and installs a resonator in the non-silica optical fiber. Therefore, the present invention may realize an all-fiber laser device that emits a ray with the mid-infrared wavelength band using only the non-silica optical fiber.

According to the present invention, a bulk-optic device is not used, non-silica optical fiber including a core doped with a rare earth element having an energy transition level corresponding to the mid-infrared wavelength band is used, a silica optical fiber is connected to the non-silica optical fiber, and a resonator is installed in the silica optical fiber. Therefore, the present invention realizes an all-fiber laser device that emits a ray with the mid-infrared wavelength band by connecting the non-silica optical fiber with the silica optical fiber.

Particularly, according to the present invention, when a laser device is realized by connecting the silica optical fibers, there is a possibility that an oscillation frequency is limited to the vicinity of the transmittance wavelength of the silica optical fiber, but very well-developed optical device manufacturing and connection technologies based on the silica optical fiber may be utilized, so that the all-fiber laser device may be easily realized.

The present invention realizes a laser device without using a bulk-optic device. By doing so, a simple resonator may be formed since optical devices do not need to be aligned, and long-term stability of the power of the laser device is excellent, and an efficiency in conversion of a pumped ray into a laser ray is high.

Also, since an output terminal of the laser device according to the present invention is formed of an optical fiber, the laser device is convenient to use, and a separate optical fiber or optical alignment is not required to guide an emitted ray to a use spot.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An all-fiber laser device for a mid-infrared wavelength band, inputting and pumping a pump ray to an optical fiber to output a laser ray, the laser device comprising:
the fiber including a non-silica optical fiber with a core doped with a rare earth element having an energy transition level corresponding to the mid-infrared wavelength band, the non-silica optical fiber being used for a gain medium.

2. The all-fiber laser device for a mid-infrared wavelength band, wherein the rare earth element comprises one element selected from the group consisting of Pr, Tb, Dy, Nd, Pm, Sm, Eu, Gd, Ho, Er, Tm, and Yb.

3. An all-fiber laser device for a mid-infrared wavelength band, the laser device comprising:
a non-silica optical fiber with a core doped with a rare earth element having an energy transition level corresponding to the mid-infrared wavelength band, the non-silica optical fiber being used for a gain medium;
a pump light source coupled to the non-silica optical fiber through an optical coupler installed in the non-silica optical fiber; and
an optical device installed in the non-silica optical fiber to constitute a resonator.

4. The laser device of claim 3, wherein the rare earth element comprises one element selected from the group consisting of Pr, Tb, Dy, Nd, Pm, Sm, Eu, Gd, Ho, Er, Tm, and Yb.

5. The laser device of claim 3, wherein the optical device constituting the resonator is formed of a Bragg grating and thus the resonator comprises a Fabry-Parrot resonator.

6. The laser device of claim 3, wherein the pump light source comprises a laser diode, and the optical coupler comprises a WDM (wavelength division multiplexing) optical coupler.

7. The laser device of claim 3, wherein the optical device comprises an optical isolator installed In the non-silica optical fiber and generating laser oscillation in only one direction, and a band-pass optical filter installed in the non-silica optical fiber and selecting a laser oscillation wavelength; and
the optical isolator and the band-pass optical filter are connected with each other in a ring shape, so that the resonator is a ring-shaped resonator, and an optical fiber coupler is installed in the non-silica optical fiber to output a ray.

8. An all-fiber laser device for a mid-infrared wavelength band, the laser device comprising:
a non-silica optical fiber with a core doped with a rare earth element having an energy transition level corresponding to the mid-infrared wavelength band, the non-silica optical fiber being used for a gain medium;
a silica optical fiber connected to both ends of the non-silica optical fiber;
a pump light source coupled to the non-silica optical fiber through an optical coupler installed in the non-silica optical fiber; and
an optical device installed in the non-silica optical fiber to constitute a resonator.

9. The laser device of claim 8, wherein the rare earth element comprises one element selected from the group consisting of Pr, Tb, Dy, Nd, Pm, Sm, Eu, Gd, Ho, Er, Tm, and Yb.

10. The laser device of claim 8, wherein the optical device constituting the resonator is formed of a Bragg grating and thus the resonator comprises a Fabry-Parrot resonator.

11. The laser device of claim 8, wherein the pump light source comprises a laser diode, and the optical coupler comprises a WDM (wavelength division multiplexing) optical coupler.

12. The laser device of claim 8, wherein the optical device comprises an optical isolator installed in the silica optical fiber and generating laser oscillation in only one direction, and a band-pass optical filter installed in the silica optical fiber and selecting a laser oscillation wavelength, and
the optical isolator and the band-pass optical filter are connected with each other in a ring shape, so that the resonator is a ring-shaped resonator, and an optical fiber coupler is installed in the silica optical fiber to output a ray.
